(19) United States
(12) Patent Application Publication
(10) Pub. No.: US 2005/0016288 A1
(43) Pub. Date: Jan. 27, 2005

(54) Micromechanical apparatus, pressure sensor, and method

(76) Inventors: Joerg Muchow, Reutlingen (DE); Andreas Junger, Reutlingen (DE); Hubert Benzel, Pliezhausen (DE); Juergen Nitsche, Gammertingen (DE); Frank Schaefer, Tuebingen (DE); Andreas Duell, Stuttgart (DE); Heinz-Georg Vossenberg, Pfullingen (DE); Christoph Schelling, Reutlingen (DE)

Correspondence Address: KENYON & KENYON, ONE BROADWAY, NEW YORK, NY, 10004, US

(21) Appl. No.: 10/853,793

(22) Filed: May 25, 2004

(30) Foreign Application Priority Data
May 26, 2003 (DE) 10323559.0

(51) Int. Cl. G01L 9/00

(52) U.S. Cl. 73/754

(57) ABSTRACT

A micromechanical apparatus, a pressure sensor, and a method, a closed cavity being provided beneath a membrane, the membrane having a greater thickness in a first membrane region than in a second membrane region.

### BACKGROUND INFORMATION

Various methods are already used for the production of membranes by micromechanics. These include wet-chemical etching using substances such as, for example, KOH; an etching operation of this kind proceeds anisotropically, and selectively etches specific crystal directions or along specific crystal directions. In addition, there are etching methods, for example gas-phase etching, in which deep vertical etch holes are produced at lithographically defined locations. Annealing at high temperatures under vacuum causes a relocation of the silicon in such a way that the holes become closed at the surface and a cavern remains in the interior. Using a two-dimensional arrangement, it is likewise possible in this fashion to produce membranes made of single-crystal silicon. A material of this kind is also referred to as a “silicon-on-nothing” or SON material.

### SUMMARY OF THE INVENTION

The apparatus, the pressure sensor, and the method according to the present invention have, in contrast, the advantage that silicon-based membranes can be manufactured easily and economically, and in particular can be optimized for specific purposes. These membranes can be used, for example, for pressure sensing. According to the present invention, it is possible to use such pressure sensors in very economical fashion, for example in finger pressure sensors, intelligent robot grippers, and other applications. Such structures are also of interest for microelectronic low-power applications, since they furnish a thin single-crystal silicon layer directly above an electrical insulator. The “electrical insulator” here refers to the enclosed vacuum in the cavity or cavern; this type of single-crystal silicon layer directly above the cavern can thus also be described as a silicon-on-insulator (SOI) structure. According to the present invention, it is advantageously possible to manufacture any desired membrane sizes. It is furthermore possible to manufacture any desired lateral membrane geometries. According to the present invention it is furthermore also possible to manufacture any desired vertical membrane geometries, for example an anvil membrane or a bridge membrane. The method is characterized by good reproducibility. It is furthermore possible, according to the present invention, to manufacture any desired membrane thicknesses and to manufacture any desired cavern heights. Since the method according to the present invention is a surface micromechanical process, it therefore has shorter etching times especially as compared with bulk micromechanical processes, since it is not necessary to etch through the entire wafer. According to the present invention, the membrane is made in particular of single-crystal silicon; this can, for example, be additionally oxidized or patterned in accordance with the requirements of the application. The method according to the present invention is embodied, in particular, in a microelectronics-compatible fashion, so that the method according to the present invention can be applied, and microelectronic circuits can be manufactured, simultaneously on one and the same substrate.

It is particularly advantageous that, in a special embodiment according to the present invention, the membrane is provided in single-crystal fashion. As a result, for example, features (for example piezosensors) that require the crystal structure of single-crystal silicon can be provided on the membrane. It is furthermore advantageous that, in a further embodiment according to the present invention, the membrane is provided in oxidized fashion in a subregion. It is thereby possible to produce a so-called anvil membrane. It is additionally advantageous that the membrane is provided in single-crystal fashion in the first membrane region beneath the oxidized region. It is thereby possible to obtain a thermally well-insulated membrane or a thermally well-insulated center region of the membrane, with a homogeneous temperature distribution. It is furthermore advantageous that in a further embodiment according to the present invention, the membrane is provided in oxidized fashion in a lateral subregion. It is thereby possible to provide both good thermal insulation of the center region of the membrane, and a single-crystal structure of the membrane in the center of the membrane.

### BRIEF DESCRIPTION OF THE DRAWINGS

FIG. 1 shows a first preliminary stage of the apparatus according to the present invention.

FIG. 2 shows a second preliminary stage of the apparatus according to the present invention.

FIG. 3 shows a first embodiment of the apparatus according to the present invention.

FIG. 4 shows a second embodiment of the apparatus according to the present invention.

FIG. 5 shows a third embodiment of the apparatus according to the present invention.

FIG. 6 shows a fourth embodiment of the apparatus according to the present invention.

FIG. 7 shows a fifth embodiment of the apparatus according to the present invention.

### DETAILED DESCRIPTION

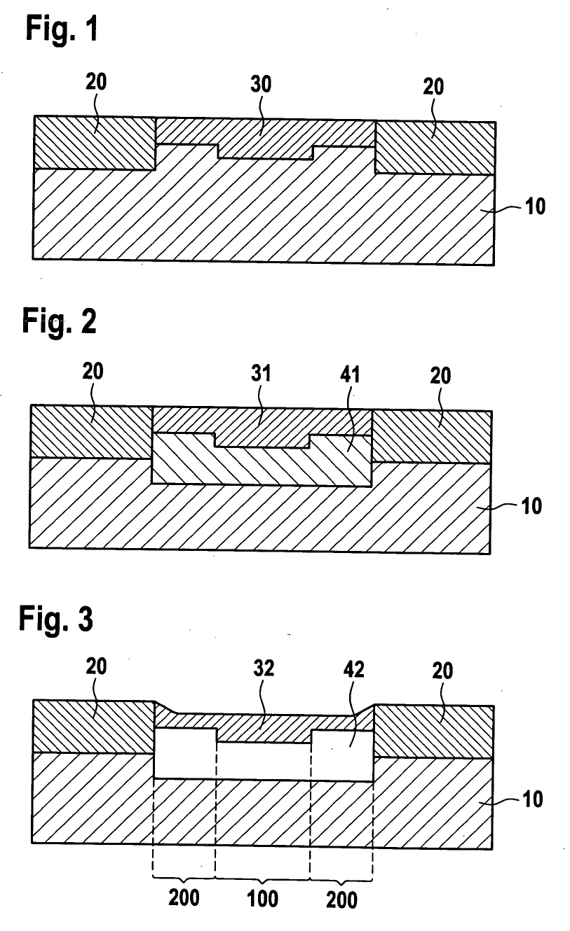

FIG. 1 depicts a first preliminary stage of the apparatus according to the present invention. Negatively doped regions 20 are provided on a substrate 10 that is provided, according to the present invention, in particular as a silicon substrate. Silicon substrate 10 itself is provided as a positively doped substrate. In a region of substrate 10 labeled with reference character 30, a more greatly positive doping of the material is introduced into substrate material 10. The more greatly positively doped regions 30 labeled with reference character 30 can be of any desired shape. In particular, the greater positive doping of region 30 can be introduced more deeply into substrate material 10 at some locations than at other locations. This results, according to the present invention, in different depths for the greater positive doping 30.

FIG. 2 depicts a second preliminary stage of the apparatus according to the present invention. FIG. 2 shows the status of the apparatus according to the present invention after an etching operation that results in a porous silicon region in the substrate regions labeled with reference characters 31, 41. Once again, as in FIG. 1, the substrate is labeled with reference character 10 and the negatively doped regions with reference character 20. Provision is made according to the present invention for producing porous silicon, by using an anodizing operation, in the substrate region labeled with reference character 31, the degree of porosity in the region labeled with reference character 31 being less than the degree of porosity in the region labeled with reference character 41. The porosity in the region labeled with reference character 41 is greater than 60% or 80%, and can reach almost 100%. In order to define the regions that will be electrochemically etched and that result in porous silicon in the regions labeled with reference characters 31, 41, it is possible on the one hand, as depicted in FIGS. 1 and 2, to use implanted or diffused doping layers; or it is possible to use cover layers as a mask for electrochemical etching (anodization). The use of masks is not depicted, however, in FIGS. 1 and 2. It is moreover also possible according to the present invention to use deposited insulating layers as an etching mask, although this is also not depicted in the drawings. As a result of electrochemical etching, the wafer is etched in such a way that the low-porosity region labeled with reference character 31 is formed in the vicinity of the surface, and the high-porosity region labeled with reference character 41 is formed therebeneath.

After cleaning and drying of the wafer, in particular in a reducing environment, the wafer is transferred into a vacuum apparatus. Here the wafer is heated, either in a reducing or an inert atmosphere or under ultra-high vacuum, to comparatively high temperatures of, for example, 800° C. to 1300° C. The reducing atmosphere encompasses, for example, hydrogen. The inert atmosphere encompasses, for example, argon. The heating results in relocation of the porously etched silicon. The material in the lower region labeled with reference character 41 in FIG. 2, which is provided in more highly porous fashion, is relocated in such a way that instead of the region labeled with reference character 41 in FIG. 2, a cavity labeled with reference character 42 in FIG. 3 is created. The lower-porosity layer on the surface, which is labeled with reference character 31 in FIG. 2, is also relocated and forms a single-crystal silicon membrane element labeled with reference character 32 in FIG. 3. The thickness of membrane 32 can be determined by way of the anodization parameters or the dopant distribution of the region labeled with reference character 30 in FIG. 1. As a result, it is possible for membrane 32 to have a greater thickness in a first membrane region labeled with reference character 100 in FIG. 3 than in a second membrane region labeled with reference character 200 in FIG. 3. Substrate 10, and the greatly negatively doped regions 20, are once again also depicted in FIG. 3.

The first embodiment of the apparatus according to the present invention depicted in FIG. 3 encompasses membrane 32 in the form of a so-called silicon anvil membrane.

FIG. 5 depicts a single-crystal silicon membrane 32, embodied in similar fashion, in a third embodiment according to the present invention of the apparatus, the membrane of the third embodiment of the invention in FIG. 5 being referred to as a so-called silicon bridge membrane. The latter once again has a first membrane region 100 and a second membrane region 200, the first membrane region having a greater thickness than second membrane region 200. As compared with FIG. 3, however, in the third embodiment of the apparatus according to the present invention first membrane 100 is provided externally, i.e. laterally on membrane 32, and second membrane region 200 is provided in the center of membrane 32. In the first embodiment of the apparatus according to the present invention in FIG. 3, it is the reverse: first membrane region 100 is provided in the center, and second membrane 200 is provided laterally on membrane 32.

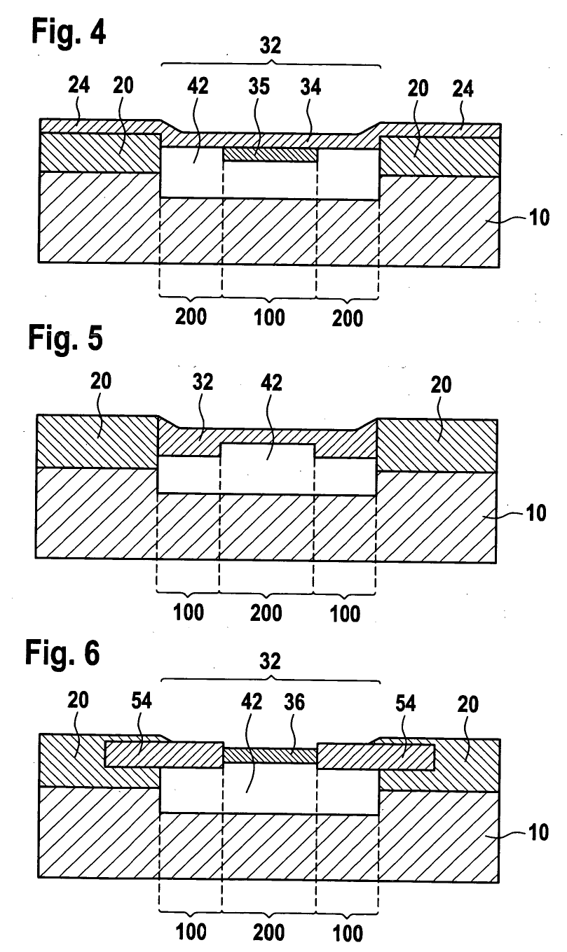

FIG. 4 depicts a variant of the first embodiment of the apparatus according to the present invention. Here a surface region of the overall apparatus is provided in oxidized fashion. The surface region of greatly negatively doped region 20 constitutes an oxide layer 24, and the surface region of membrane 32 constitutes a subregion 34 of membrane 32 which is also provided in oxidized fashion. Oxide layer 24, 34 is provided, in particular, as a thermal oxide layer. In the second exemplified embodiment of the apparatus according to the present invention, a single-crystal region 35 of membrane 32 is provided beneath oxidized region 34 of membrane 32. Once again, first membrane region 100 and second membrane region 200 are depicted in the context of the second embodiment of the apparatus. The second embodiment of the apparatus according to the present invention can also be referred to as partial oxidation of a membrane 32 provided as an anvil membrane. The single-crystal membrane region labeled with reference character 35 is also referred to as a single-crystal silicon plug. As a result of the partial oxidation of membrane 32 in the context of the second embodiment of the invention in FIG. 4, particularly good thermal insulation from the environment can be achieved because of the low thermal conductivity of the silicon oxide of the inner region of the membrane (i.e. of region 35 of membrane 32). At the same time, the silicon plug beneath the membrane ensures a homogeneous temperature distribution in the inner region of the membrane. With the use of a nitride mask, it is once again possible in this context for portions of the membrane to be selectively oxidized or not. This is depicted in FIG. 6.

In FIG. 6, membrane 32 is provided as a single-crystal silicon region in a center region that is labeled with reference character 36. Provided to the sides thereof are oxidized regions 54 which have been selectively oxidized and contribute to the thermal decoupling of the region of membrane 32 labeled with reference character 36. Oxidized regions 54 (thermal oxide) are to be construed, in their portions that belong to membrane 32, as “oxidized subregions” 54 of membrane 32. Once again, first membrane region 100 and second membrane region 200 are depicted, as well as substrate 10 and greatly negatively doped regions 20 (n-doping). Reference character 10 designates the p-silicon wafer.

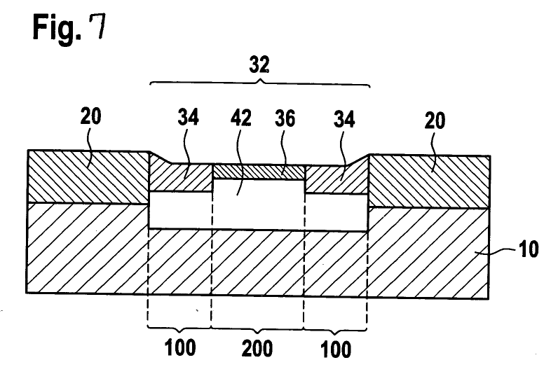

A further embodiment of the apparatus according to the present invention is depicted in FIG. 7. Here, proceeding from the apparatus according to FIG. 5, membrane 32 is locally oxidized. The partial oxidation thereby achieved takes place in the thicker regions 100 that surround thinner region 200 of membrane 32. This results in a membrane 32 that is made up of a single-crystal region 36 and oxidized regions 34 surrounding that region. In contrast to the apparatus shown in FIG. 6, however, the oxidation is not extended into greatly negatively doped regions 20.

The apparatus according to the present invention is used in particular as a pressure sensor. It is advantageous in this context that in the cavity below membrane 32 depicted in FIGS. 3 through 6 and labeled with reference character 42, a reference volume having a specific reference pressure can be produced in a particularly well definable and reproducible fashion, so that a pressure sensor manufactured with the apparatus according to the present invention likewise exhibits particularly good reproducibility.

1. An apparatus comprising:
a substrate; and
a membrane situated above the substrate, the membrane covering a closed cavity, the membrane having a greater thickness in a first membrane region than in a second membrane region.

2. The apparatus according to claim 1, wherein the membrane is provided in single-crystal fashion.

3. The apparatus according to claim 1, wherein the membrane is oxidized at least in one subregion.

4. The apparatus according to claim 3, wherein the entire membrane is oxidized.

5. The apparatus according to claim 3, wherein the membrane is provided in single-crystal fashion in the first membrane region beneath the oxidized subregion.

6. The apparatus according to claim 1, wherein the membrane is oxidized in a lateral subregion.

7. The apparatus according to claim 1, further comprising a single-crystal region, substances for a manufacture of semiconductor components being present in the single-crystal region.

8. A pressure sensor comprising a micromechanical apparatus including:
a substrate; and
a membrane situated above the substrate, the membrane covering a closed cavity, the membrane having a greater thickness in a first membrane region than in a second membrane region.

9. A method for manufacturing an apparatus, the method comprising:
providing a substrate; and
providing a membrane situated above the substrate, the membrane covering a closed cavity, the membrane having a greater thickness in a first membrane region than in a second membrane region.
